(19) United States
(12) Patent Application Publication
(10) Pub. No.: US 2003/0131018 A1
(43) Pub. Date: Jul. 10, 2003

(54) Common business data management

(75) Inventors: Glenn C. Godoy, Endicott, NY (US); Mark Anthony Musa, Brackney, PA (US); Amy J. Snavely, Binghamton, NY (US)

Correspondence Address: John R. Pivnichny, Ph.D., IBM Corporation, N50/040-4, 1701 North Street, Endicott, NY, 13760, US

(73) Assignee: International Business Machines Corporation, Armonk, NY

(21) Appl. No.: 10/042,403

(22) Filed: Jan. 9, 2002

(51) Int. Cl. G06F 7/00

(52) U.S. Cl. 707/104.1

(57) ABSTRACT

A method and structure for maintaining common business control data across a plurality of applications is provided. A model of business rules is developed and entered in a relational database. Business control data is entered into the database according to the rules and thereafter respective portions of the business control are disseminated to a plurality of applications. A common data administration application may be used to receive input from logged on individuals and automated feed from a source system and enter business data into the relational database. The applications are designed to integrate portions of the common data model and rules. The data model itself is reproduced in part across all of the applications so that when the common data administration application updates data and rules, that data is propagated to distributed relational databases that have the same structure and rules.

### TECHNICAL FIELD OF THE INVENTION

The present invention relates generally to the field of data maintenance and more particularly to maintenance of common business data for a plurality of applications.

### BACKGROUND OF THE INVENTION

Businesses often use various computer applications to record information for different functions of the business. Typically each function will select an application that best suits its requirements. Thus, the purchasing function may select one application, accounts payable another, production scheduling another. Each of these applications requires business and configuration data to be setup and maintained in order to execute the application. In many cases the data required for one application is the same data required for another application. Consequently differing solutions are created as part of each application to perform the same data setup and maintenance tasks on much of the same data. For example data on commodities, units of measure, companies, and suppliers may be common across many applications. It would therefore be a significant improvement to provide a way to manage all of this common data in one common system and then propagate the data as needed to different applications. In the case of large companies the applications may be run on various processors or servers at geographically separate locations throughout the world, thus complicating the problems with time, language, and cultural/legal differences.

Some common data systems have been developed. For example, in U.S. Pat. No.5,864,821 Hosoda et al. describe a method and apparatus for transmitting data at various stages of decision from a common database. Parameters representing degrees of decision of the data are stored along with the data. A progress stage is specified on the basis of the data stored and the degrees of decision. Data is read out of the common database and transmitted to a destination by referring to a destination definition table.

Brichta et al. in U.S. Pat. No. 5,884,310 describe a system and method for integrating distributed data. Their system has a plurality of source systems each having a source database, an extraction engine, and a transformation engine. An extraction engine extracts data from a respective source database. The respective transformation engine then transforms the extracted data into a common format and a common file structure. A common database server having a common database, a common database controller, and a load engine, receives the transformed data and loads the data into the common database.

The abstract of Japanese Patent JP 10105385 by Shuichi et al. describes converting data corresponding to respective offices into common data using a first mapping part. A main program is prepared and executed with the common data. After processing, the common data is converted back to data corresponding to respective offices by a second mapping part.

The two U.S. Pat. Nos. 5,864,821 and 5,884,310 as well as the abstract of Japanese Patent JP 10105385 are incorporated herein by reference. However, even with such developments there remains a need to provide an improved way to manage and propagate common business data. It is believed that such an improvement would constitute a significant advancement in the art.

### OBJECTS AND SUMMARY OF THE INVENTION

It is therefore a principal object of the present invention to provide an improved method of managing business control data.

It is another object to provide a system wherein such an improved method of operational capability is possible.

It is further object to provide a computer program product having such an operational capability.

These and other objects are attained in accordance with one embodiment of the invention wherein there is provided a method of updating business control data, comprising the steps of, developing a model of business rules and building the rules into a modeled database, entering business control data into the modeled database, and disseminating to a plurality of applications, respective portions of the business control data according to the business rules.

In accordance with another embodiment of the invention there is provided a system for updating business control data, comprising, a relational database having rules defining a business model having a plurality of applications, business control data in the relational database, and dissemination means coupled to the relational database for disseminating the business control data to the plurality of applications according to the business rules.

In accordance with yet another embodiment of the invention there is provided a computer program product for instructing a processor to maintain business control data, the computer program product comprising, a computer readable medium, first program instruction means for developing a model of business rules and building the rules into a modeled database, second program instruction means for entering business control data into the modeled database, and third program instruction means for disseminating to a plurality of applications, respective portions of the business control data according to the business rules, and wherein all three of the program instruction means are recorded on the medium.

### BRIEF DESCRIPTION OF THE DRAWINGS

FIG. 1 is a diagram of a common data system;

FIG. 2 shows users interfacing with a common data system;

FIG. 3 illustrates propagation of common data to geographical locations;

FIG. 4 is a more detailed view of propagation to a geographical location;

FIG. 5 is an additional detailed view of propagation to two geographical locations;

FIG. 6 illustrates a plurality of applications interacting with a common control data system;

FIG. 7 shows a model of business rules;

FIG. 8 shows an example of a commodity business model;

FIG. 9 shows an example of a catalog business model;

FIG. 10 shows a generic business model; and

FIG. 11 is a system diagram further illustrating the present invention.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

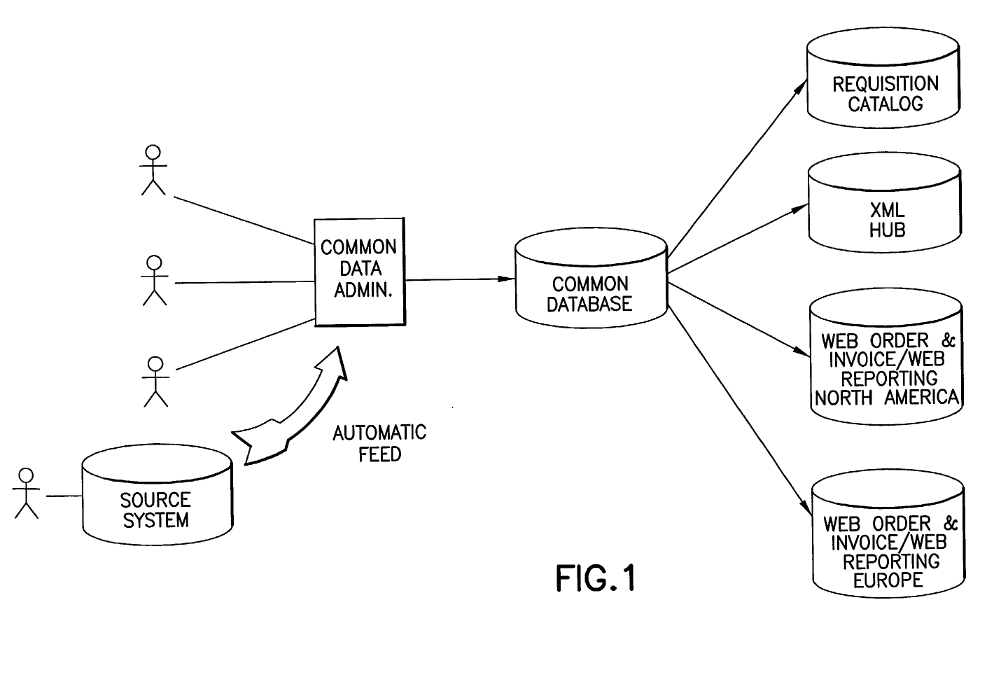

In FIG. 1 there is shown a system of updating business control data in accordance with the present invention. A common database 110 is adapted for disseminating business control data stored therein to a plurality of applications. Examples of applications are a requisition/catalog application 102, an XML Hub application 104, web order and invoice and web reporting applications for North America 106, and web order and invoice and web reporting applications for Europe 108. Any other type of business application (not shown) may also be used with the present invention. All of these applications may be running or run on a single processor. A plurality of processors located in one data center or located at various geographical locations may also be used. For a large multinational company, the processor may be located in disparate countries or continents.

The common business data in common database 110 is disseminated across paths 112 to the plurality of applications 102, 104, 106 and 108. Any type of path may be used depending on the volume of data to be disseminated, the speed at which it must be disseminated and the physical locations at which the applications are running or are to be run. The paths will also need to be compatible or adapted to operate with the types of hardware on which the applications are located and also the type of common database 110 used. For spanning long distances a network architecture including a private network or the Internet may be used.

Common database 110 is a relational database. Any type of relational database may be used such as a DB2® (DB2 is a registered trademark of International Business Machines Corp.) Database or an ORACLE database.

A model of business rules is developed and entered into common database 110. The model will have a data structure including a dissemination structure as explained below. The business rules may define the dissemination structure. Business control data is also entered into common database 110.

One way of entering the rules and business control data into common database 110 is by use of common data administration application 116 across path 114. Individuals 118 may enter rules or data by accessing common data administration application 116 using access paths 120. For example, an individual may log on to application 116 using a workstation (not shown) of any type connected to a network 120 having access to the application. Data and rules may also enter from a source system 122 using an automatic feed 128. An example of a source system would be an enterprise resource planning (ERP) system or application. Individual 124 may access source system using path 126 which may be any type path including types described as suitable for paths 120 above.

In operation, common data administration application 116, may perform various front end data management tasks and checks on the data and rules entered on paths 120 and 128 before the data or rules are entered into common database 110. Examples of such tasks and checks include but are not limited to supplier, country, company, unit of measure, language and language support, roles and authority, currency, commodity, plants, work locations, cost centers, installed applications, and buyers. Additional rules, different from the business rules just described, may be coded as program logic into common data administration application 116 to assist in performing the checks and tasks just described and to assist in entering business control data into common database 110. These additional rules remain within common data administration application 116 and are not stored in common database 110.

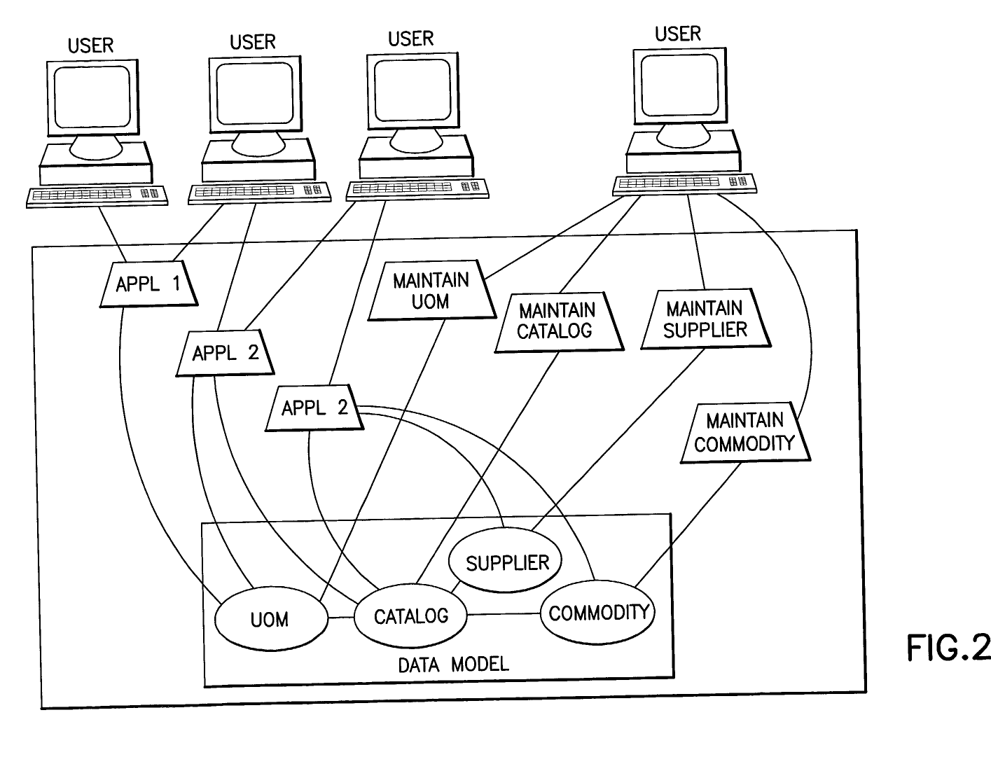

In FIG. 2 there is shown another view of individuals 232 who may be business data administrators entering business model rules or business control data using workstation 230. These rules or data may be involved with maintaining unit of measure business data 212 by accessing a portion 220 of common data administration application 116 for maintaining unit of measure. Alternatively a portion 222 for maintaining catalog data or rules 214 may be accessed. Similarly supplier data or rules 218 or commodity data or rules 216 may be maintained by accessing portions 224 or 226 respectively.

Other individuals 250 who may be application end users may be accessing one or more of the plurality of business applications 202, 204, and 206 such as those listed above using workstations 242, 244, or 246 as shown in FIG. 2. Note that a single workstation e.g. 244 may be used to access more than one application without departing from the present invention. Data Model 210 shows an interconnection structure between the various sets of data 212, 214, 216 and 218. Element 219 may represent a rule. For example rule 219 may be that a supplier 218 can provide more than one catalog 214, but a catalog 214 is provided by only one supplier 218.

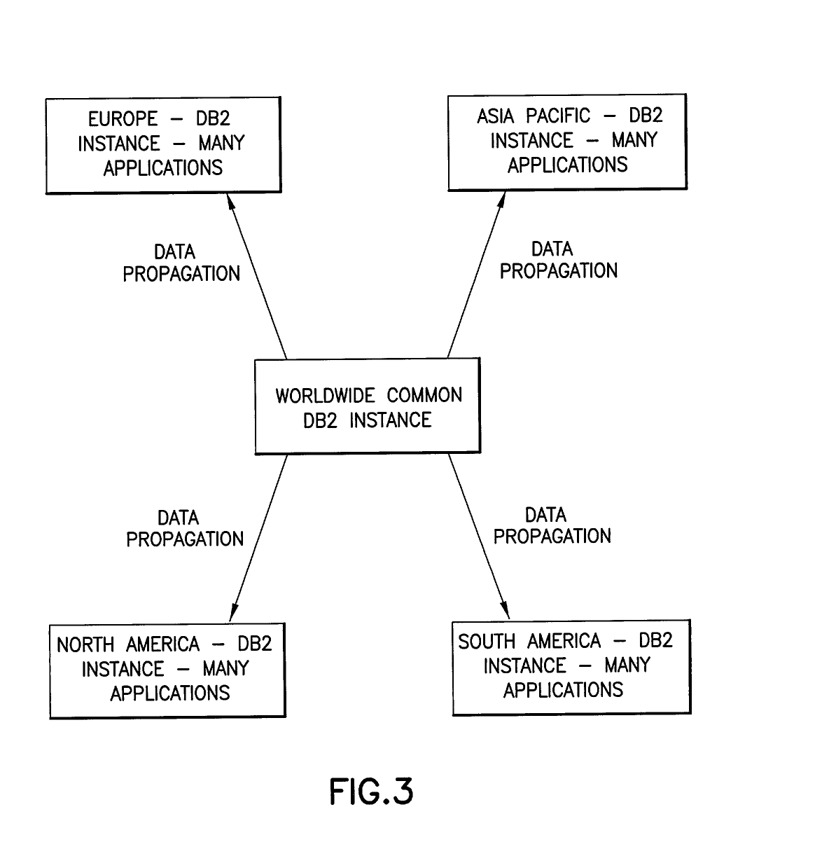

In FIG. 3 there is shown a diagram depicting disseminating common data from database 302 to a plurality of instances 304, 306, 308, 310. With this structure, only a portion of the data in the common database 302 needs to be disseminated to each instance based on the model of business rules which will define the further dissemination to particular applications at each geographical location. The instances are located in a plurality of geographical locations e.g. Europe 304, Asia Pacific 306, North America 308, and South America 310. The instances may run on servers located in the respective geographical locations which in this case are in disparate continents.

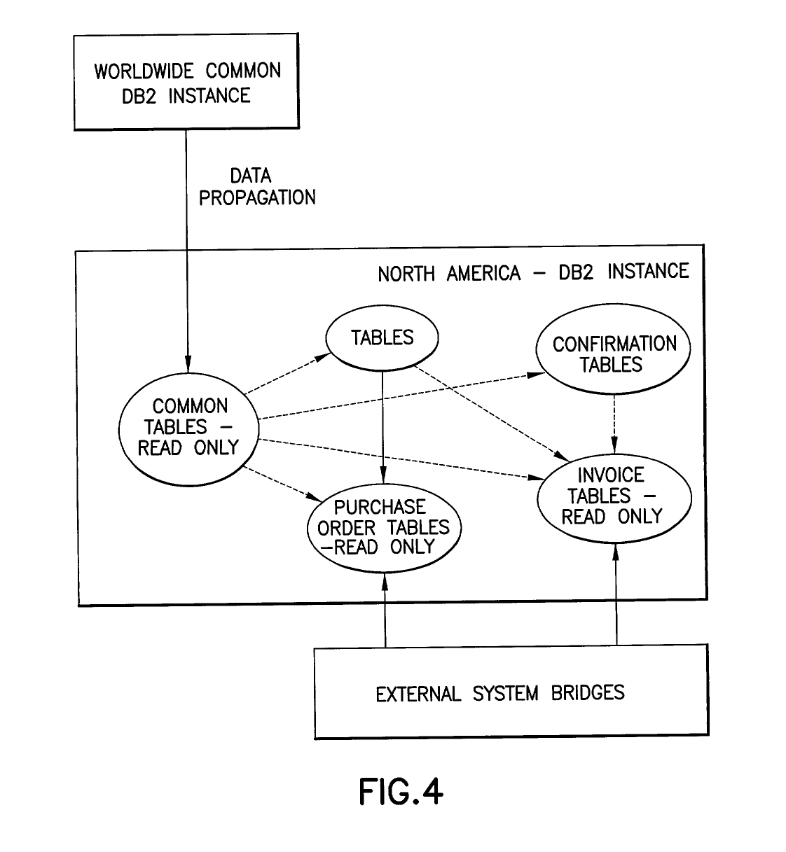

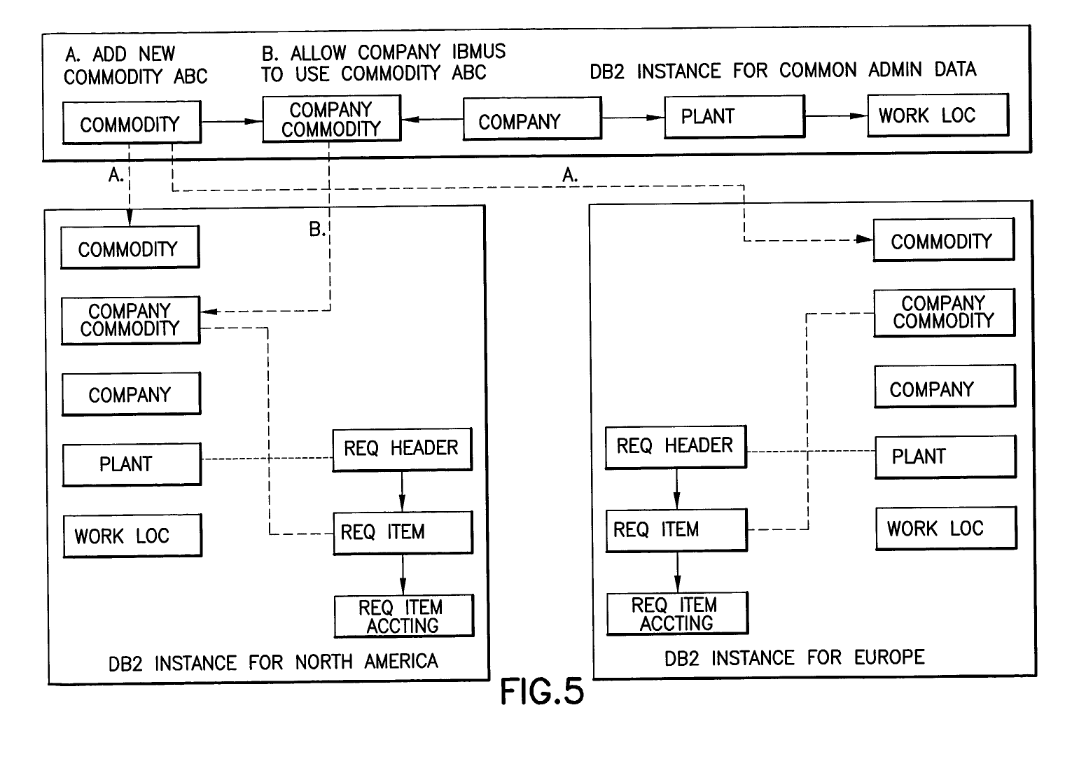

FIG. 4 shows more detail of data propagation from common database 402 to the North America DB2® Instance 404 also shown as item 308 of FIG. 3. Data is propagated to read-only tables within instance 404, thus guaranteeing the integrity of the data, preventing corruption by instance 404. From there the data may be accessed and used by applications along with additional tables 408, confirmation tables 410, purchase order tables 414, or invoice tables 412. The disseminated data may be stored in some or all of the applications in read-only form. External system bridges 416 may also have access via paths 418 to any of the additional tables.

FIG. 5 shows additional detail of how data stored in database 502 such as commodity data 504, company commodity data 506, company data 508, plant data 510 and work location data 512 is propagated to North America instance 514 and Europe instance 516. For example A, one may wish to add a new commodity e.g. ABC. The new commodity is added to commodity data 504 and then propagated to commodity data 518 in instance 514 and also to commodity data 530 in instance 516 because the commodity is used in both North America and Europe as defined by the model of business rules in database 502. In example B one may wish to allow a particular company, IBMUS, to use a commodity, ABC. After entering this change into company commodity data 506, it is propagated only to company commodity data 520 in the North America instance 514 since this company is located only in North America and has no European locations. There is therefore no need to propagate it to company commodity data 532 in instance 516. Relationships are shown in FIG. 5 such as Plant data 522 to Req Header data 524 or company commodity 520 to Req Item 526 and Req Item 526 to Req Item Accting 528. All such propagation is performed in accordance with the rules built into the modeled database as explained above.

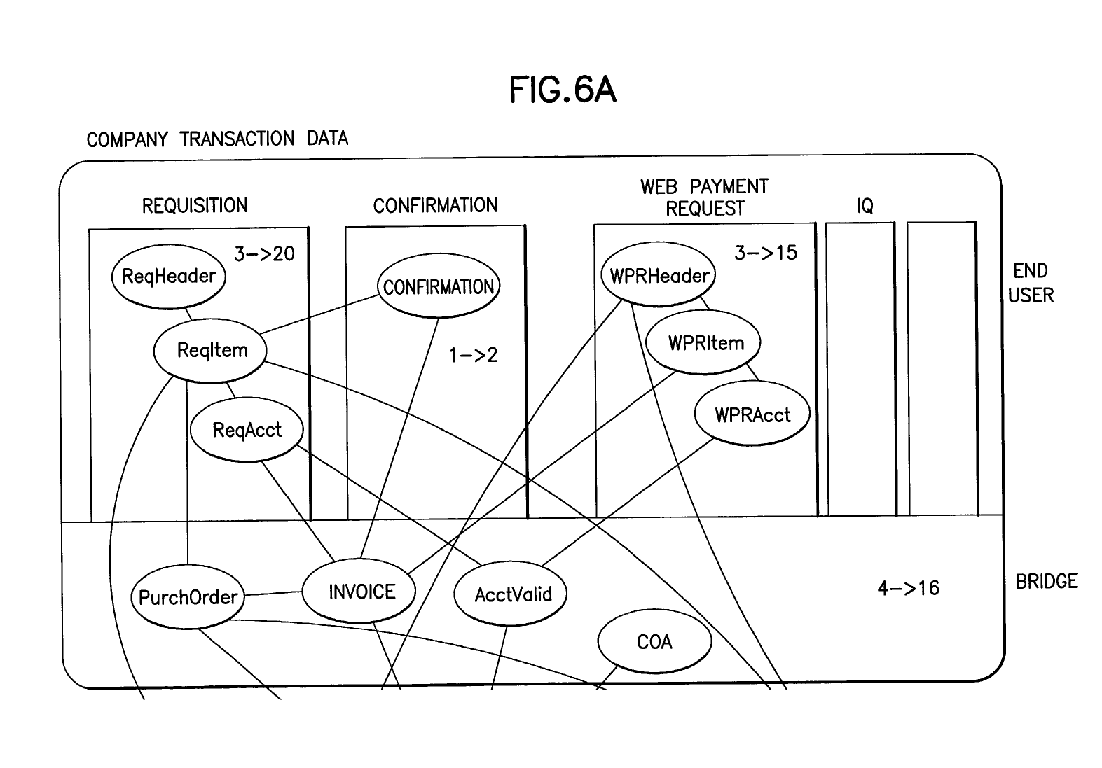

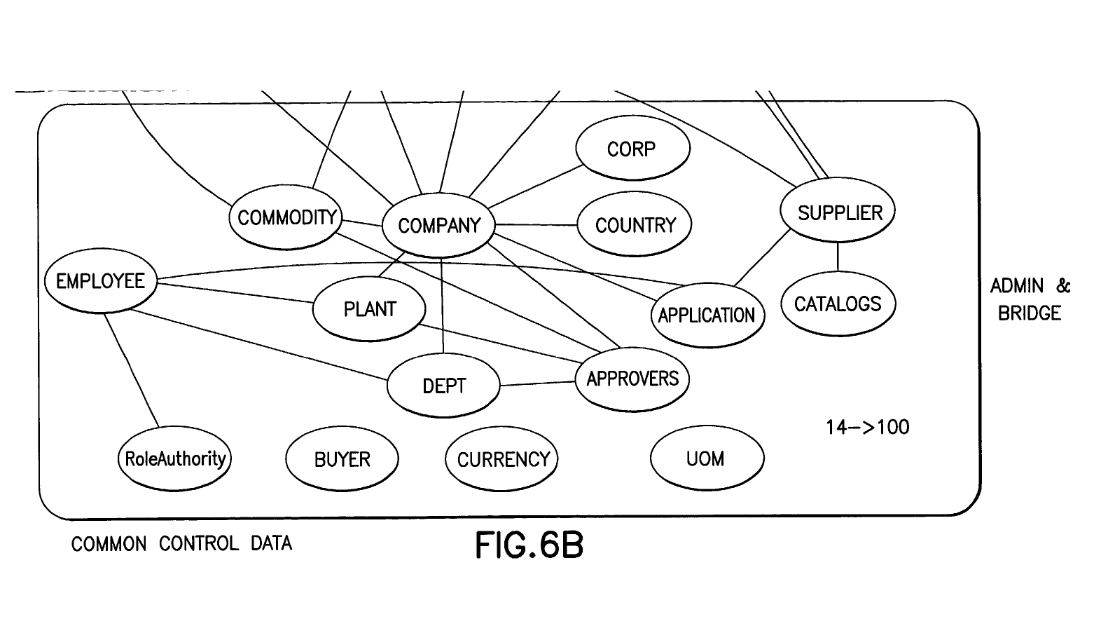

FIG. 6 shows various applications 602 accessing common control data 604. Bridge 606 may also provide sets of data and relationships.

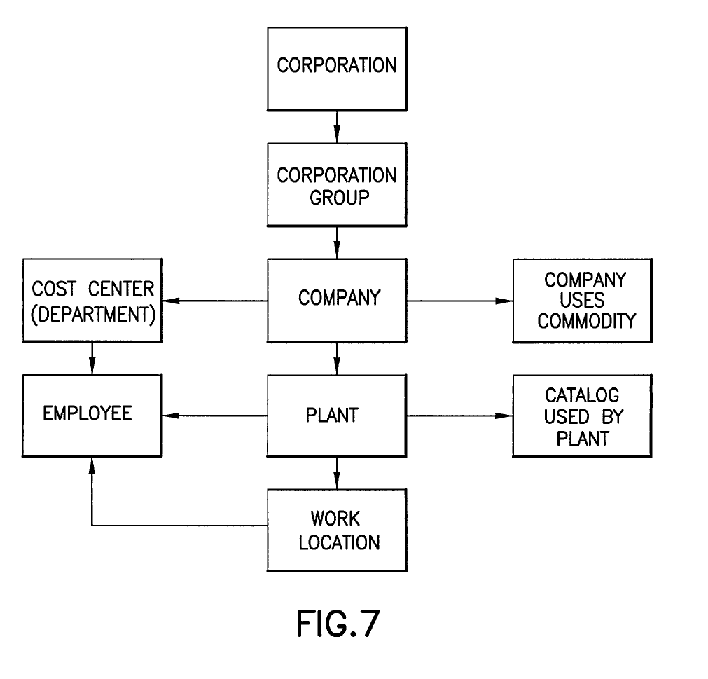

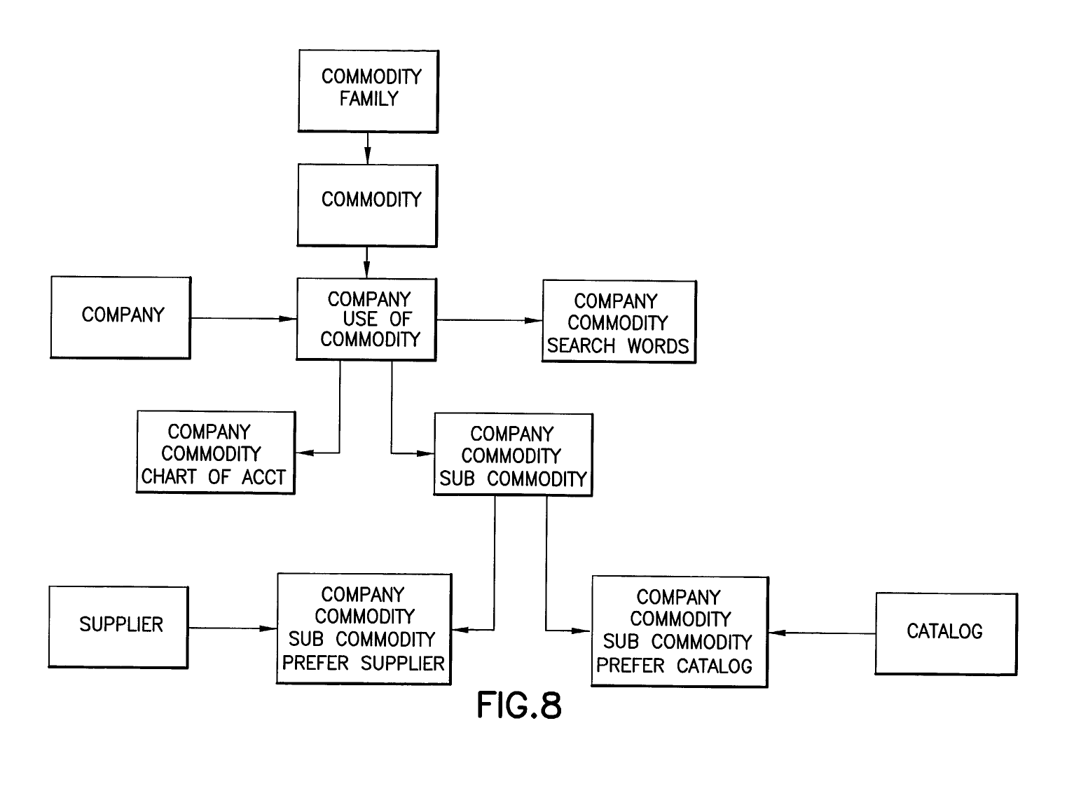

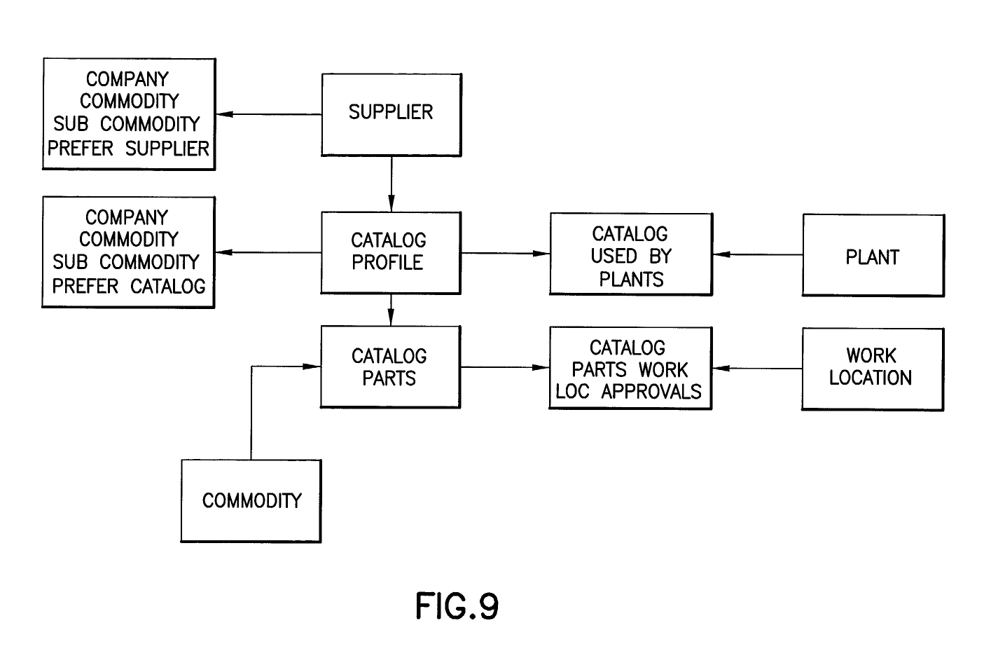

FIGS. 7-9 show structures for company data, commodity data, and catalog data respectively. Such structures are used to develop business rules which are then built into the modeled database. The rules will also define a dissemination structure.

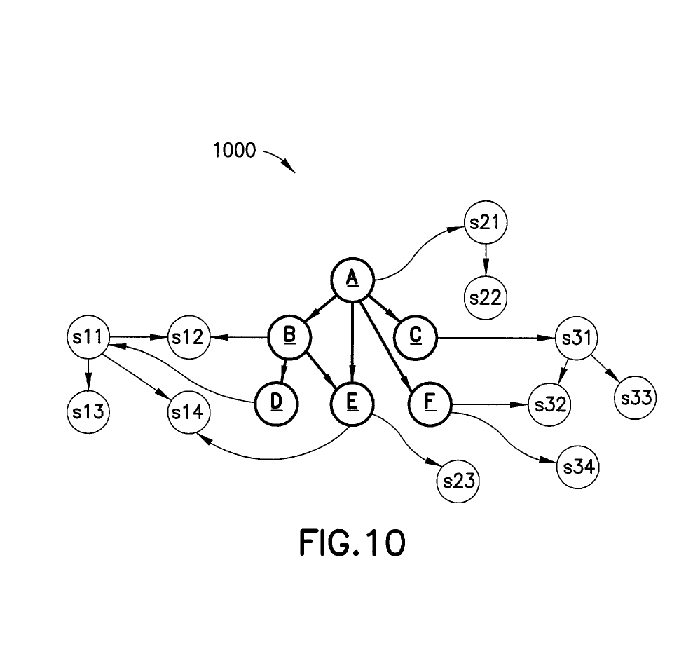

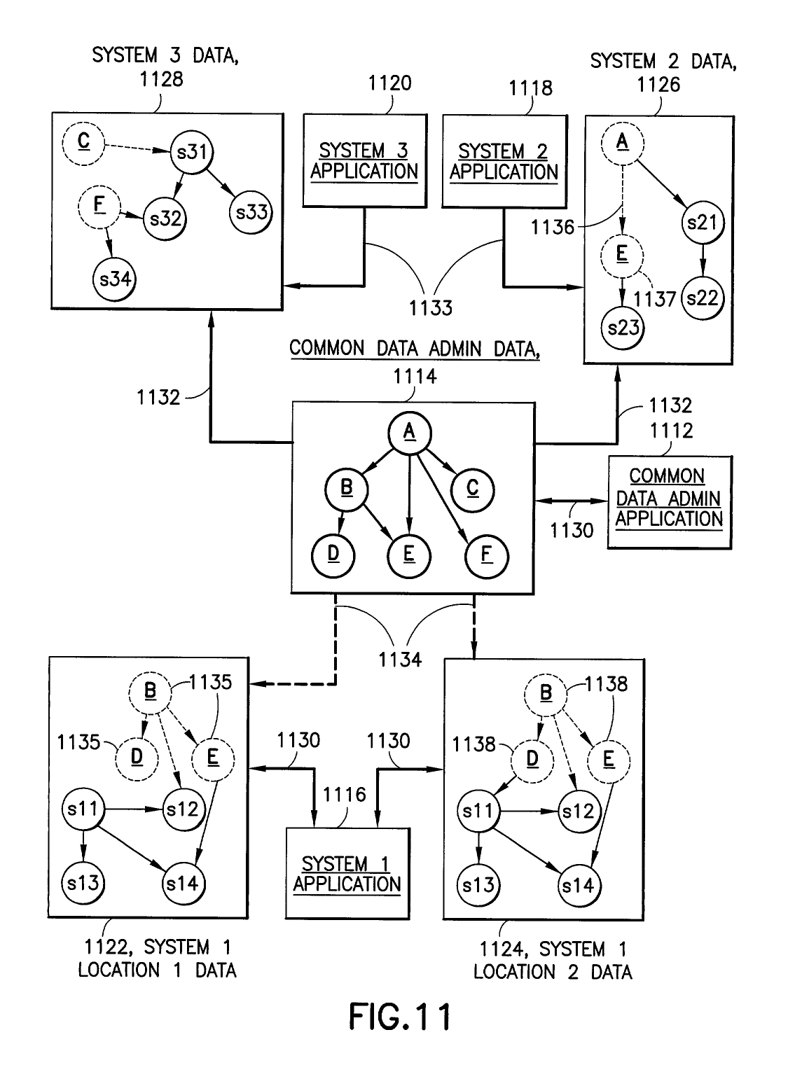

FIGS. 10 and 11 provide further explanation of the present invention. In FIG. 10 there is shown a generic business model of data and relationships for an entire business. Common data, shown as bold circles A through F and common relationships shown as bold arrows define the common data and rules used in part by all applications (not shown) with the present invention.

Other data and rules unique to specific applications are shown in FIG. 10 as normal (Not bold) circles and normal arrows. For example data sets s11, s12, s13, and s14 are unique to a first application or system. Data sets s21, s22, and s23 are unique to a second application or system. Data sets s31, s32, s33, and s34 are unique to a third application or system.

In FIG. 11 there is shown common data administration application 1112 which would correspond to element 110 of FIG. 1. Common database 1114, also called common data administration data corresponds to common database 110 of FIG. 1 and is updated by application 1112 over path 1130 corresponding to path 114 of FIG. 1. Common database 114 includes data and rules, also indicated with bold circles, letters, and arrows, corresponding to the common data and rules of business model 1000 of FIG. 10.

FIG. 11 includes by way of example and not limitation, three system applications 1, 2, and 3 shown respectively as 1116, 1118, and 1120. System 1 application 1116 accesses database, system 1 location 1 data 1122 and database, system 1 location 2 data 1124 across paths 1130. In FIG. 11 a double arrow head solid line path such as 1130 is used to designate that data access and data update is allowed across the path. A single arrow head solid line path designates data propagation in the direction of the arrow head. A dotted line indicates a read-only data path such as 1136 or data set 1137. A dashed line designates selective propagation of a subset of a common database across a path such as 1134 or a subset of a common database such as 1135. Data sets 1138 are also selectively propagated from database 1114. Selective propagation is taken to mean that data sets 1135 contain only those data set parts needed by the system 1 location 1 data, database 1122, and data sets 1138 contain only those data set parts needed by database 1124. Thus for example the data in data set B of 1122 will have some differences from the data in data set B of 1124 and that both are derived by selective propagation of data set B of 1114 but with differing selective propagation rules in 1114. System 2 application 1118 and system 3 application 1120 access and propagate data to system 2 data 1126 and system 3 data 1128 databases respectively across paths 1133.

Databases 1122 and 1124 have data sets B, D, and E which were selectively propagated from common database 1114 as just described via paths 1134. Databases 1126 and 1128 were propagated from common database 1114 via paths 1132. Data sets unique to each application as explained above are shown in FIG. 11 incorporated within their respective database along with selective common data. As also explained above, rules controlling propagation of common data whether selective or full are included in a common database 1114.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of updating business control data, comprising the steps of:
developing a model of business rules and building said rules into a modeled database;
entering business control data into said modeled database; and
disseminating to a plurality of applications, respective portions of said business control data according to said business rules.

2. The method of claim 1, wherein said rules are built to define a dissemination structure.

3. The method of claim 2, wherein said structure has a plurality of instances of said modeled database.

4. The method of claim 3, wherein said plurality of instances run on a corresponding plurality of servers located in corresponding geographical locations.

5. The method of claim 4, wherein said geographical locations are in disparate continents.

6. The method of claim 1, wherein said business control data is entered into said modeled database using a common data administration application.

7. The method of claim 6, wherein said common data administration application is adapted to receive input from logged on individuals and from an automated feed from a source system.

8. The method of claim 6, further comprising the step of entering additional rules into said common data administration application.

9. The method of claim 8, wherein said business control data is entered into said modeled database according to said additional rules.

10. A system for updating business control data, comprising:
a relational database having rules defining a business model having a plurality of applications;
business control data in said relational database; and
dissemination means coupled to said relational database for disseminating said business control data to said plurality of applications according to said business rules.

11. The system of claim 10, wherein said rules define a dissemination structure.

12. The system of claim 11, wherein said structure has a plurality of instances of said relational database.

13. The system of claim 12, wherein said plurality of instances run on a corresponding plurality of servers located in corresponding geographical locations.

14. The system of claim 13, wherein said geographical locations are in disparate continents.

15. The system of claim 10, further comprising a common data administration application coupled to said relational database for entering said business control data into said relational database.

16. The system of claim 15, wherein said common data administration application is adapted to receive input from logged on individuals and from an automated feed from a source system.

17. The system of claim 15, further comprising additional rules in said common data administration application.

18. The system of claim 17, wherein said common data administration application is adapted to enter said business control data into said relational database according to said additional rules.

19. A computer program product for instructing a processor to maintain business control data, said computer program product comprising:
a computer readable medium;
first program instruction means for developing a model of business rules and building said rules into a modeled database;
second program instruction means for entering business control data into said modeled database; and
third program instruction means for disseminating to a plurality of applications, respective portions of said business control data according to said business rules; and wherein
all three of said program instruction means are recorded on said medium.
